(19) United States
(12) Patent Application Publication
(10) Pub. No.: US 2005/0115153 A1
(43) Pub. Date: Jun. 2, 2005

(54) Vehicle door and method for closing a vehicle door window

(76) Inventors: Dominique Roda, Les Longevilles Mont D'Or (FR); Chris Rhodes, Orleans (FR)

Correspondence Address: CARLSON, GASKEY & OLDS, P.C., 400 WEST MAPLE ROAD, SUITE 350, BIRMINGHAM, MI, 48009, US

(21) Appl. No.: 10/996,615

(22) Filed: Nov. 23, 2004

(30) Foreign Application Priority Data
Nov. 28, 2003 (FR) FR 03 13 995

(51) Int. Cl. E05D 15/10

(52) U.S. Cl. 49/213

(57) ABSTRACT

A vehicle door includes a window glass, a slide connected to the window glass, and at least one guide rail for guiding the slide along a substantially cylindrical trajectory. One end of the guide rail or rails includes a shaping or conformation that changes the cylindrical trajectory of the slide at the end of travel. The friction of the window glass against the seal is kept low while the window glass is moved and lifted. The window glass is in a sealing position as it reaches the end of the upward travel.

### REFERENCE TO RELATED APPLICATIONS

This patent application claims priority to French Patent Application No. FR 03 13 995 filed on Nov. 28, 2003.

### BACKGROUND OF THE INVENTION

This invention relates generally to a vehicle door and a method for closing a window of the vehicle door.

In a vehicle door with a frame, a seal can receive a window glass to guide the window glass when moving and to ensure sealing when the window glass is in a raised position. The friction between the moving window glass and the seal can cause resistance. The drawback is that the driving force of the window glass must be increased to overcome this resistance.

There is therefore a need for a vehicle door that reduces the driving force of the window glass.

### SUMMARY OF THE INVENTION

The present invention provides a vehicle door including a window glass, a slide connected to the window glass, and a guide rail for guiding the slide along a substantially cylindrical trajectory. One end of the guide rail includes a shaping or conformation that changes the substantially cylindrical trajectory of the slide.

In one embodiment, the shaping or conformation inclines the trajectory of the slide towards an inner skin of the door. In another embodiment, the guide rail has a radius, and the concavity is directed towards the inner skin of the door. According to yet another embodiment, one end of the guide rail includes the shaping or conformation, which has a reduced radius.

According to one embodiment, the shaping or conformation of the guide rail has a section with a reduced radius followed by a section with an increased radius at the end of the guide rail. Alternately, the shaping of conformation of the guide rail has a section with a reduced radius followed by a section where the radius has a concavity that is opposite to the concavity of the guide rail.

According to another embodiment, the door includes a plurality of slides connected to the window glass and a plurality of guide rails that guide the slides along a cylindrical trajectory. One end of each of the guide rails has a shaping or conformation that changes the cylindrical trajectory of the slides.

According to one embodiment, the door also includes a door shell, and the window glass is guided by two guide rails in the door shell and by one guide rail outside the door shell. An upper end of each of the guide rails includes the shaping or conformation.

According to one embodiment, a seal guides the window glass along the guide rail that is outside the door shell. According to another embodiment, the window glass is pushed against the seal when the slide is located at the shaping or conformation of the guide rail. According to yet another embodiment, the window glass is offset from the seal when the slide is not located at the shaping or conformation of the guide rail.

According to one embodiment, the slides that are guided by the two guide rails that are in the door shell have two walls that define a rail channel. The two walls have jaws that clamp the guide rail. The jaws are curved in the direction of the guide rail and extend transverse to the guiding trajectory. According to one embodiment, the slides each have two facing pairs of jaws, and each of the pairs of jaws clamp one of the guide rails.

The invention also relates to a method for closing a window glass in a vehicle door. The method includes the steps of offsetting the window glass from a guide rail during movement of the window glass and pushing the window glass against the guide rail when the slide is located at the shaping or conformation of the guide rail when the window glass is in the raised position.

According to one embodiment, the door includes a frame with a seal around the edge of the frame. The window glass is pushed against the seal when the window glass is in the raised position.

Other characteristics and advantages of the invention will become apparent when reading the following detailed description of the embodiments of the invention, given as an example only and with reference to the drawings.

### BRIEF DESCRIPTION OF THE DRAWINGS

FIG. 1 is a schematic perspective view of a vehicle door according to one embodiment;

FIG. 2 is a profile view of a guide rail;

FIG. 3 is a perspective view of a guide rail and one type of slide;

FIG. 4 is a sectional view of the guide rail and the slide of FIG. 3;

FIG. 5 is a perspective view of another type of slide;

FIG. 6 is a perspective view of another type of slide; and

FIGS. 7 to 9 show stages of closing a window glass in the vehicle door in FIG. 1.

### DETAILED DESCRIPTION OF PREFERRED EMBODIMENTS

FIG. 1 shows a schematic perspective view of a vehicle door 10 according to one embodiment. The door 10 includes a door shell 12, a frame 14 connected to an upper edge of the door shell 12, and a window glass 16 moveable relative to the door 10. The window glass 16 is shown in a lowered position inside the door shell 12. The window glass 16 can be moved to a raised position in which the edge of the window glass 16 contacts the frame 14 of the door 10. When the window glass 16 is in the raised position, the window glass 16 ensures sealing with a seal between an interior and an exterior of the vehicle. The seal can be arranged around the edge of the frame 14, as well as along the upper edge of the door shell 12. The seal is located on either side of a window glass channel along the upper edge of the door shell 12. When the window glass 16 leaves or enters the door shell 12, the seal brushes against the window glass 16.

The door 10 also includes a slide 18 connected to the window glass 16 and a guide rail 20. Between the raised position and the lowered position, the moving window glass 16 follows the guide rail 20 by the slide 18. The guide rail 20 guides the slide 18 along an approximately cylindrical trajectory. Cylindrical trajectory is defined to mean a curved trajectory along the directrix of a cylinder. The guide rail 20 is concave to provide such a trajectory, and the concavity of the guide rail 20 is directed towards an inner skin of the door 10 and towards an interior of the vehicle. The concavity of the guide rail 20 allows the window glass 16 to cylindrically move between the raised position and the lowered position. The door 10 has a generally curved shape, and the cylindrical movement of the window glass 16 allows the window glass 16 to adapt to the shape of the door 10.

The guide rail 20 guides the window glass 16 outside the door shell 12 in the frame 14. If the guide rail 20 is an upright of the frame 14, the guide rail 20 is then a window glass run. The seal of the frame 14 can be along the guide rail 20. The window glass 16 is guided relative to the guide rail 20 with the help of the slide 18. Thus, the window glass 16 is not guided relative to the guide rail 20 by a lateral edge of the window glass 16. This reduces the friction between the window glass 16 and the guide rail 20 because it is the slide 18 that principally contacts the guide rail 20.

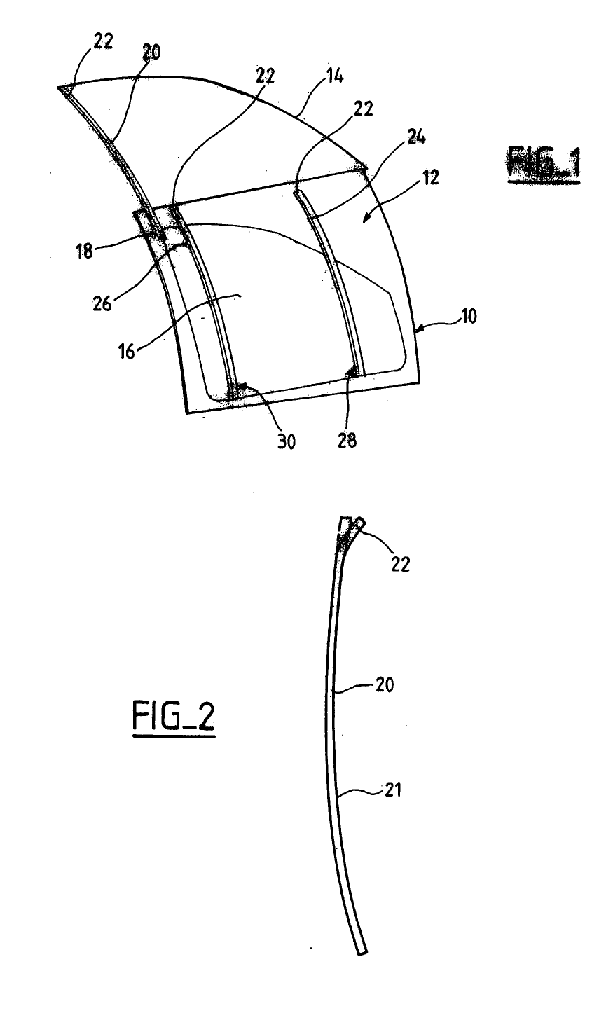

One end of the guide rail 20 includes a shaping or conformation 22 that changes the cylindrical trajectory of the slide 18. The shaping 22 is more clearly visible in FIG. 2, which shows a profile view of the guide rail 20. The guide rail 20 includes a main body 21 that is curved according to a certain radius that corresponds to the curvature of the window glass 16. The radius is, for example, 1200 mm. The concavity of the radius faces towards the interior of the vehicle. The slide 18 follows a regular trajectory along the main body 21. One end of the guide rail 20 includes the shaping 22. The shaping 22 inclines the trajectory of the slide 18 towards the inner skin of the door 10, and the slide 18 is diverted towards the inner skin of the door 10. The shaping has, for example, a smaller radius than the radius of the main body 21 of the guide rail 20, for example, 200 mm. The radius of the shaping 22 can be five to ten times smaller than the radius of the main body 21 of the guide rail 20. In particular, the shaping 22 allows the guide rail 20 to curve towards the interior of the vehicle an increased amount.

In FIG. 2, the continuation of the main body 21 is shown with a dotted line, while the shaping 22 is more curved than the main body 21. Thus, when the slide 18 reaches the end of the guide rail 20 having the shaping 22, the trajectory of the slide 18 changes, and the slide 18 moves towards the interior of the vehicle. The window glass 16 is connected to the slide 18, and the slide 18 carries the window glass 16 with it while it moves towards the interior of the vehicle. This pushes the window glass 16 against the seal. Preferably, an upper end of the guide rail 20 at the top of the frame 14 includes the shaping 22, pushing the window glass 16 against the seal when the window glass 16 is in the raised position to ensure sealing. Moreover, when the window glass 16 is not located at the shaping 22 of the guide rail 20, the window glass 16 is offset from the seals, reducing the friction between the window glass 16 and the seals.

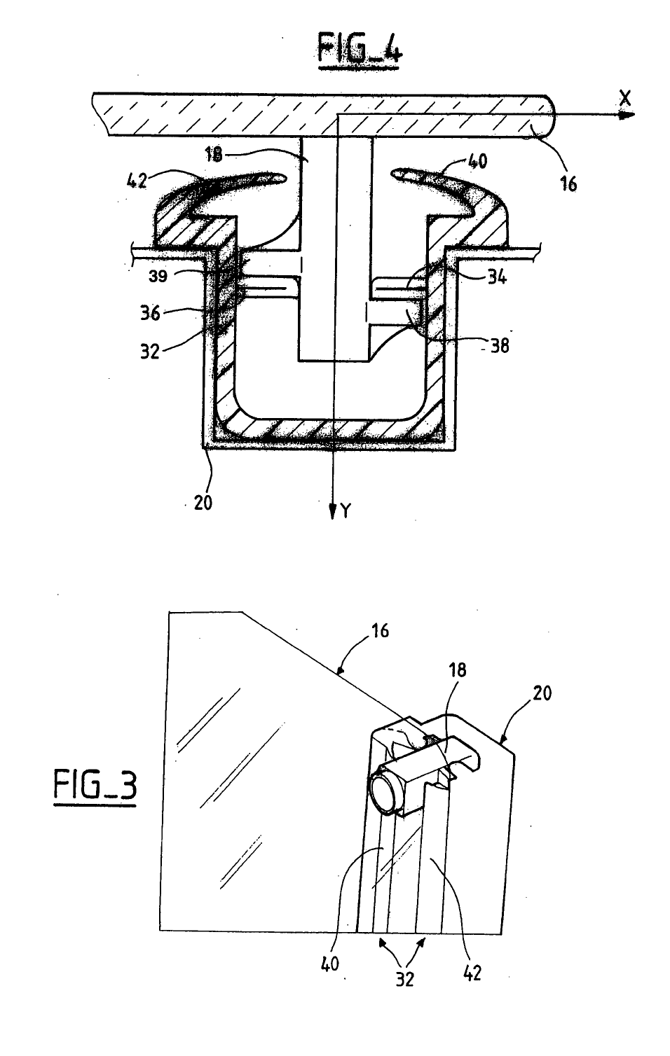

FIG. 3 shows a perspective view of an embodiment of the slide 18 connected to the window glass 16. A seal 32 is arranged along the guide rail 20, and the slide 18 is guided by and slidingly mounted in the guide rail 20. Thus, the window glass 16 is guided by the slide 18 as the window glass 16 moves in the frame 14. The window glass 16 is guided relative to the guide rail 20 by the slide 18, which maintains its stability and reduces the friction between the window glass 16 and the seals 32.

FIG. 4 shows a section view of the window glass 16, the slide 18, and the seal 32 in the guide rail 20. The arrow X points along the longitudinal axis of the vehicle, and the arrow Y points transverse to the longitudinal axis of the vehicle towards the interior of the vehicle. The guide rail 20 has a substantially U-shaped section, and the seal 32 is inserted in the U. The seal 32 can be glued or held by any other means. The seal 32 has one or more lips 40 and 42 between the guide rail 20 and the window glass 16. The lips 40 and 42 extend from arms of the U of the guide rail 20 in the direction of the slide 18. The window glass 16 does not contact the lips 40 and 42 when the window glass 16 moves between the lowered position and the raised position. When the slide 18 reaches the raised position, the window glass 16 is pushed against the lips 40 and 42, as described below.

The guiding of the slide 18 in the guide rail 20 is shown in FIG. 4, as an example. The guide rail 20 has shoulders 34 and 36 that extend from the arms of the U-shaped guide rail 20 towards the interior of the U. The shoulders 34 and 36 can also extend from the seal 32. The shoulders 34 and 36 extend along the guide rail 20 and cooperate with the ribs 38 and 39 that extend from the slide 18 in the direction of the arms of the U of the guide rail 20. The shoulder 34 cooperates with the rib 38, and the shoulder 36 cooperates with the rib 39. Thus, the slide 18 slides along the guide rail 20 by the sliding of the ribs 38 and 39 on the shoulders 34 and 36.

The shoulders 34 and 36 and the ribs 38 and 39 provide a sliding connection between the slide 18 and the guide rail 20. The ribs 38 and 39 and the shoulders 34 and 36 maintain the slide 18 along the guide rail 20. In the direction indicated by the arrow Y in FIG. 4, the shoulders 34 and 36 and the ribs 38 and 39 alternate on either side of the slide 18. On the right hand side of the slide 18, the rib 38 is located between the shoulder 34 and the bottom of the guide rail 20 or the seal 32. This pushes the window glass 16 against the seals 32 when the slide 18 is located in the shaping 22. On the left hand side of the slide 18, the shoulder 36 is located between the rib 39 and the bottom of the guide rail 20 or the seal 32. This moves the window glass 16 away from the seal 32 when the window glass 16 is not located in the zone of the shaping 22 and reduces the friction between the window glass 16 and the lips 40 and 42 of the seal 32.

The slide 18 can also be guided by ribs on the slide 18 that are guided in grooves in the guide rail 20 or the seal 32.

FIG. 1 further shows two other guide rails 24 and 26 in the door shell 12. The guide rails 24 and 26 each guide a slide 28 and 30, respectively, that is connected to the window glass 16. The slides 28 and 30 are driven by a window glass regulator (not shown). The window glass regulator can also only include one guide rail. However, two guide rails 24 and 26 further stabilizes the window glass 16 in the door shell 12. The two guide rails 24 and 26 hold the window glass 16 in the plane of the door 10, and the guide rail 20 prevents the window glass 16 from falling out of the plane of the door 10. It is hereafter assumed, in a non-exhaustive way, that the window glass regulator includes two guide rails 24 and 26 in the door shell 12 and one guide rail 20 in the frame 14. The guide rails 24 and 26 are curved in the same manner as the guide rail 20. The curvature of the guide rails 20, 24 and 26 allows the window glass 16 to have a cylindrical trajectory and allows the window glass 16 to follow the general curved shape of the door 10.

The guide rails 24 and 26 preferably also have a shaping or conformation 22 similar to the shaping 22 of the guide rail 20. The shaping 22 on the guide rails 24 and 26 can be seen in FIG. 1. The shapings 22 allow the slides 28 and 30 to move towards the interior of the vehicle and to carry the window glass 16 with them. The shapings 22 are located at the upper end of the guide rails 24 and 26 at the top of the door shell 12.

In FIG. 1, the window glass 16 has a substantially triangular shape, for example. The base of the triangle is guided in the door shell 12 along the guide rails 24 and 26 by the slides 28 and 30. The apex of the triangle is guided in the frame 14 along the guide rail 20 by the slide 18. Moreover, each of the guide rails 20, 24 and 26 has a shaping 22, preferably located at the upper end. Thus, when the window glass 16 is in the raised position, the slides 18, 28 and 30 are located in the shapings 22 of each guide rail 20, 24 and 26. However, a different type of guiding is possible, with two guide rails in the frame 14 and one guide rail in the door shell 12.

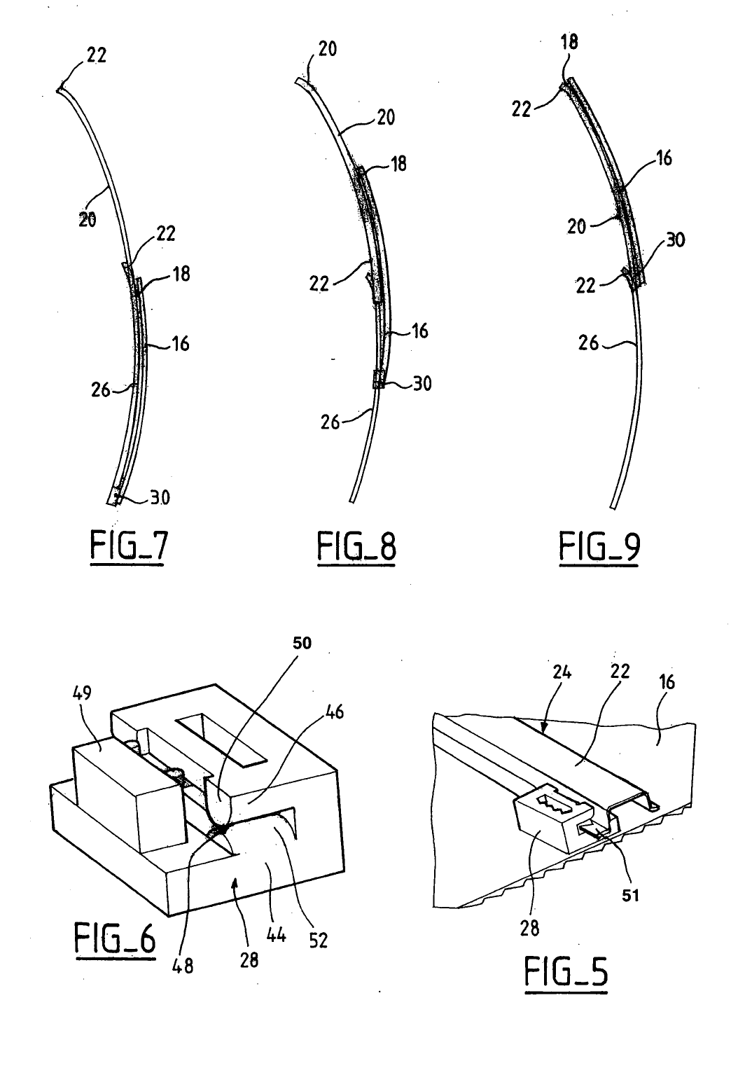

FIGS. 5 and 6 show perspective views of another type of slide that guides the window glass 16 relative to the guide rails 24 and 26. The guide rails 24 and 26 are located in the door shell 12. The guide rails 24 and 26 are the rails of a window glass regulator, not shown. The window glass regulator includes, for example, a cable drive, and the mechanism drives the slides 28 and 30 by a cable.

FIG. 5 shows the window glass 16 and the slide 28 or 30 connected to the window glass 16. One of the guide rails 24 and 26 is also shown, for example the guide rail 24. The guide rail 24 guides the slide 28 along a cylindrical trajectory. One end of the guide rail 24 includes a shaping 22 that changes the cylindrical trajectory of the slide 28. The shaping 22 has, for example, a reduced radius. Alternatively, in the direction of the end of the guide rail 24, the shaping 22 of the guide rail 24 has a section with a reduced radius followed by a section having an increased radius. Alternately, the shaping 22 of the guide rail 24 includes a section with a reduced radius followed by a section where the curvature has a concavity opposite to that the concavity of the guide rail 24.

FIG. 6 shows in more detail an example of the slide 28. The slide 28 includes two walls 44 and 46 that define a rail channel 48 and can also include a stop 49 that faces the rail channel 48. The slide 28 clamps the guide rail 24 between the walls 44 and 46, and the window glass regulator drives the slide 28 along the guide rail 24. As shown in FIG. 5, the guide rail 24 includes an L-shaped profile 51. One arm of the L extends into the rail channel 48, and the other arm extends between the stop 49 and the rail channel 48. The stop 49 prevents the slide 28 from coming out of the guide rail 24 in a direction in the plane of the window glass 16 and transverse to the direction of guiding. Preferably, the slide 28 is inserted from the end of the guide rail 24 and in the guiding direction of the slide 18. The slide 28 can also be inserted between the ends of the guide rail 24 by clipping. The slide 28 is then manipulated to insert the L-shaped arms of the guide rail 24 into the rail channel 48.

FIG. 6 further shows the zones of contact between the slide 28 and the guide rail 24. The walls 44 and 46 of the slide 28 have jaws 50 and 52 that clamp the guide rail 24. The jaws 50 and 52 extend transverse to the guiding trajectory along the guide rail 24 and are curved towards the guide rail 24. The jaws 50 and 52 are each a half-cylinder with the curved edges facing each other. Thus, the contact between each of the jaws 50 and 52 and the guide rail 24 extends along a generatrix of the jaws 50 and 52, reducing the contact between the slide 28 and the guide rail 24 and therefore friction.

According to one embodiment, the slide 28 includes two facing pairs of jaws 50 and 52. The slide 28 includes two contact zones with the guide rail 24, increasing the stability of the slide 28 along the guide rail 24. Moreover, as the guide rail 24 is curved, the curved jaws 50 and 52 allow the guide rail 24 to tilt in contact with the jaws 50 and 52 transverse to a directrix of the jaws 50 and 52. This compensates for the radius of the guide rail 24. Moreover, the jaws 50 and 52 also adapt to the shaping 22 of the guide rail 24, in particular when the slide 28 reaches the shaping 22 of the guide rail 24. In one embodiment, the shaping 22 has a reduced radius relative to the radius of the guide rail 24. When the slide 28 reaches the shaping 22, the slide 28 straddles the shaping 22 and the main body 21 of the guide rail 24. The guide rail 24 is then curved in the rail channel 48. The curved jaws 50 and 52 allow the guide rail 24 to tilt in contact with the jaws 50 and 52, allowing it to have a free passage when the guide rail 24 slides with a variable radius and compensates for the change in the radius of the guide rail 24.

FIGS. 7 to 9 show stages of closing of the window glass 16 in the door 10 in FIG. 1. FIGS. 7 to 9 show the guide rails 20 and 26 and the window glass 16 in profile. The slides 18 and 30 connected to the window glass 16 and guided, respectively, by the guide rails 20 and 26 are also shown. An upper end of each of the guide rails 20 and 26 has a shaping 22. The guide rails 20 and 26 are curved, and the concavity of the guide rails 20 and 26 is directed towards the interior of the vehicle on the left hand side in FIGS. 7 to 9. The guide rails 20 and 26 are curved to adapt the movement of the window glass 16 to the generally curved shape of the door 10. The guide rails 20 and 26 can have the same radius, and the shapings 22, for example, have a smaller radius. In FIGS. 7 to 9, the shaping 22 of the guide rails 20 and 26 are located at the upper end. Thus, the ends are inclined towards the interior of the vehicle. Moreover, and according to the profile view in FIGS. 7 and 9, the guide rails 20 and 26 overlap, and the lower end of the guide rail 20 is lower in the door 10 than the upper end of the guide rail 26 including the shaping 22.

In FIG. 7, the window glass 16 is in the lowered position inside the door shell 12. The slides 18 and 30 are positioned at the lower end of each of the guide rails 20 and 26. In this position, the window glass 16 may or may not be completely inside the door shell 12. As shown in FIG. 5, the window glass 16 is held away from the guide rail 26 both by the slide 30 (which is placed between the guide rail 26 and the window glass 16) and by the slide 18 (which maintains a space between the window glass 16 and the guide rail 20).

In FIG. 8, the window glass 16 moves in the direction of the frame 14 to be closed. The slides 18 and 30 move along the guide rails 20 and 26, respectively, along a cylindrical trajectory. The window glass 16 partially occupies the frame 14. A space is visible between the window glass 16 and the guide rails 20 and 26. Thus, during the travel of the window glass 16, the window glass 16 is offset from the guide rail 20, and in particular from the seal 32. The offset reduces the friction between the window glass 16 and the guide rails 20 and 26, and if applicable, the seal 32. It is also possible that the window glass 16 is not completely separated from the seal 32. In particular, the flexible lips 40 and 42 can contact the window glass 16. However, the window glass 16 is not forced against the seal 32, reducing the friction between the window glass 16 and the seal 32 when the window glass 16 moves along the guide rail 20.

FIG. 9 shows the window glass 16 in the raised position at the end of upward travel. The window glass 16 is pushed against the guide rail 20. In particular, the window glass 16 is pushed against the seal 32. In this position, the contact between the window glass 16 and the seal 32 ensuring sealing. To allow the window glass 16 to be pushed against the seal 32, the slides 18 and 30 have reached the shapings 22 of the guide rails 20 and 26. The guide rails 20 and 26 are then curved more towards the interior of the vehicle at the shapings 22, and the slides 18 and 30 are carried towards the interior of the vehicle. The change in trajectory imposed upon the slide 18, which is connected to the top of the window glass 16, allows the upper edge of the window glass 16 to enter the roof seal. Moreover, the slide 30 drives the window glass 16 towards the interior of the vehicle when the slide 30 reaches the shaping 22 of the guide rail 26. The lower end of the guide rail 20 is lower in the door 10 than the shaping 22 of the guide rail 26, and the bottom of the window glass 16 is then also forced against the seal 32. The guide rail 24 also includes the shaping 22, and the entire window glass 16 is pushed against the guide rails 20 and 24 and against the seal of the frame 14.

In the embodiment of FIG. 1, the window glass 16 is forced towards the interior of the vehicle by the three slides 18, 28 and 30. This pushes the window glass 16 against the seal 32 and allows the upper edge of the window glass 16 to insert into the roof seal. Thus, the friction of the window glass 16 against the seal 32 is reduced as long as the window glass 16 moves between the lowered position and the raised position. However, when the window glass 16 arrives in the raised position in the frame 14, the window glass 16 is pushed against the seal 32 of the frame 14 at the end of upward travel. The window glass 16 is then placed in a sealing position when it is closed.

Of course, this invention is not limited to the embodiments described as an example. Thus, the number of guide rails is not limited to that given as an example in the description. Moreover, the slides and the guide rails can be considered and protected independently of the other components of the door.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A vehicle door comprising:
a window glass;
a slide connected to the window glass; and
a guide rail for guiding the slide along a substantially cylindrical trajectory, wherein an end of the guide rail includes a shaping that changes the substantially cylindrical trajectory of the slide.

2. The door according to claim 1, further including an inner skin, wherein the guide rail has a radius having a concavity, and the concavity of the guide rail is directed towards the inner skin of the door.

3. The door according to claim 2, wherein the shaping of the guide rail has a reduced radius.

4. The door according to claim 2, wherein the shaping of the guide rail includes a section having a reduced radius followed by a section having an increased radius.

5. The door according to claim 2, wherein the shaping of the guide rail includes a section having a reduced radius that is followed by a section having a radius with a section concavity that is opposite to the concavity of the guide rail.

6. The door according to claim 1, further including an inner skin, wherein the shaping inclines the substantially cylindrical trajectory of the slide towards the inner skin of the door.

7. The door according to claim 6, wherein the guide rail has a radius having a concavity, and the concavity of the guide rail is directed towards the inner skin of the door.

8. The door according to claim 7, wherein the shaping of the guide rail has a reduced radius.

9. The door according to claim 7, wherein the shaping of the guide rail includes a section having a reduced radius followed by a section having an increased radius.

10. The door according to claim 2, wherein the shaping of the guide rail includes a section having a reduced radius that is followed by a section having a radius with a section concavity that is opposite to the concavity of the guide rail.

11. The door according to claim 1, further comprising a plurality of slides connected to the window glass and a plurality of guide rails for guiding each of the plurality of slides along the substantially cylindrical trajectory, and each of the plurality of guide rails includes an end having the shaping that changes the substantially cylindrical trajectory of each of the plurality of slides.

12. The door according to claim 11, further including a door shell, wherein the plurality of slides each comprise two walls that define a rail channel, each of the two walls having jaws that clamp one of the plurality of guide rails, and the jaws extend transverse to a guiding trajectory of the plurality of slides and are curved towards the plurality of guide rails.

13. The door according to claim 11, wherein each of the plurality of slides includes two facing pairs of jaws that each clamp one of the guide rails.

14. The door according to claim 1, further comprising a door shell, and the guide rail comprises two guide rails in the door shell and one guide rail outside the door shell, and the window glass is guided by the two guide rails in the door shell and by the one guide rail outside the door shell, the two guide rails in the door shell and the one guide rail outside the door shell each including an upper end having the shaping.

15. The door according to claim 1, further including a door shell and a seal that guides the window glass along the guide rail, and the guide rail is located outside the door shell.

16. The door according to claim 15, wherein the window glass is pushed against the seal when the slide is located at the shaping of the guide rail.

17. The door according to claim 15, wherein the window glass is offset from the seal when the slide is not located at the shaping of the guide rail.

18. The door according to claim 1, further comprising a door shell, and the guide rail includes an upper end having the shaping, and the guide rail is located outside the door shell to guide the window glass.

19. A method for closing a window glass in a vehicle door, the vehicle door comprising the window glass, a slide connected to the window glass, and a guide rail for guiding the slide along a substantially cylindrical trajectory, and the guide rail includes an end having a shaping that changes the substantially cylindrical trajectory of the slide, the method comprising the steps of:
offsetting the window glass from the guide rail during movement of the window glass; and
pushing the window glass against the guide rail when the slide is located at the shaping of the guide rail.

20. The method as recited in claim 19, wherein the door comprises a frame having a seal around an edge of the frame, and the window glass is pushed against the seal when the slide is located at the shaping of the guide rail.
